(19) United States
(12) Patent Application Publication
(10) Pub. No.: US 2009/0219395 A1
(43) Pub. Date: Sep. 3, 2009

(54) Measurement and Display for Video Peak Jitter with Expected Probability

(75) Inventors: Daniel G. Baker, Beaverton, OR (US); Barry A. McKibben, Beaverton, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/065,243

(22) PCT Filed: Aug. 28, 2006
(86) PCT No.: PCT/US06/33756

§ 371 Date: Sep. 2, 2008

Related U.S. Application Data
(60) Provisional application No. 60/712,303, filed on Aug. 29, 2005.

(51) Int. Cl. H04N 17/00

(52) U.S. Cl. 348/180; 348/E17.001

(57) ABSTRACT

A system and method are provided to generate a histogram of jitter peak values within histogram hardware. The histogram is then transferred to a jitter analyzer, which is implemented in either dedicated hardware or software running on a general purpose processor. The jitter analyzer calculates a cumulative distribution function (CDF) array and a complementary cumulative distribution function (CCDF) array based upon the histogram, and determines the peak jitter values based upon a probability value.

This application claims the benefit of U.S. Provisional No. 60/712,303, filed Aug. 29, 2005.

### TECHNICAL FIELD

The present invention relates to jitter measurements, and more particularly to jitter measurements of video, including serial digital interface (SDI) video.

### BACKGROUND

The jitter associated with serial digital data affects the performance of systems that rely on serial data to send or receive data. As the speed of the signal increases the effect of jitter increases the probability of failure in accurately transmitting and receiving the data. Modern video is increasingly being transmitted in a serial digital format, and the data rate continues to increase, which makes being able to accurately measure and characterize jitter of growing importance.

The Society of Motion Picture and Television Engineers (SMPTE) promulgates standards related to SDI that require limits on peak-to-peak jitter. In order to ensure compliance with this and other standards, requires jitter measurement equipment. Current SDI jitter measurement equipment uses simple positive and negative peak detectors to measure positive jitter and negative jitter. These peak detectors provide the largest peak in some time interval. Unfortunately, there is no official, or de facto, standard value for this time interval. Furthermore, there are not even suggested recommendations for the proper time interval, or time window, over which to indicate the largest peak. There is also no established criterion to justify a particular time window. Accordingly, manufactures of jitter measurement equipment simply use a time interval, or equivalent number of samples, that allows their equipment to produce a jitter peak-to-peak readout updated about once per second. Jitter always has some component of random jitter, which typically has an unbounded peak jitter extent. Due to this random jitter, the longer the detection windows, or the larger the sample sizes, the higher the probability of measuring a larger maximum peak jitter value. Generally speaking, the longer the detection window, the larger the maximum peak jitter value provided by the measurement system. In some modern SDI video source, deterministic jitter has been reduced significantly, such that the random jitter, which is unbounded, can create significant differences in the peak-to-peak measurements among equipment from different manufactures. It is common for one jitter measurement instrument to report a peak-to-peak jitter below the SMPTE specified limit, while another instrument reports the same source as being above the SMPTE limit, and therefore out of specification simply because the max jitter peak was detected over a longer time interval or record length than the first instrument.

Since the presence of random jitter makes any measurement inherently probabilistic in nature, merely picking any particular peak detection window would still fail to properly address the issue. A measurement system and method is needed that associates a probability of occurrence with an indicated peak-to-peak jitter value. A more fully characterized jitter measurement method would also provide a better relationship between the jitter measurement, and a Bit-Error-Ratio (BER), or probability of a bit error, which is a common measurement associated with an SDI receiver that just meets the minimum standardized jitter limits. With a proper methodology established, video standards bodies could not only specify limits on the peak-to-peak jitter, but also the associated probability, which would allow measurement systems from different manufactures to return consistent jitter values on the same signal.

The details and improvements over the prior solutions will be discussed in greater detail below.

### SUMMARY

Accordingly, a system and method for measuring peak, and peak-to-peak jitter in connection with associated probabilities is provided. Embodiments of the system and method are optimized to work with existing, standardized video SDI jitter measurement signal processing, and replaces peak detectors.

A jitter measurement system comprising histogram hardware to store jitter data as a histogram, and a jitter analyzer to determine the peak jitter values based upon the histogram data and a probability value is provided. The histogram hardware allows a sufficiently large amount of data to be accumulated in a histogram to allow the jitter calculations to be made based upon probability. In some embodiments, the histogram hardware obtains jitter data from a clock recovery circuit. In other embodiments the jitter data is based upon an eye pattern sampler.

A method is provided to calculate the peak jitter values, based upon the data provided by the histogram hardware. Cumulative distibution function (CDF) and complementary cumulative distribution function (CCDF) arrays are calculated. The positive jitter peak is determined based upon a probability value by comparing the CCDF array to the probability value and determining the point at which the CCDF array is less than the probability value. The jitter value, for example in UI, that corresponds to the point at which the CCDF array is less than the probability value is then provided as the positive peak value. The negative jitter peak is similarly determined based upon the CDF array.

A display is also provided the overlays a dynamic jitter limit marker over an eye pattern diagram to indicate the respective jitter peaks for a probability value.

The present application claims priority benefit to a U.S. Provisional entitled, “New, Fast, Jitter Algorithm for Plotting Video PP Jitter Associated with Expected Probability” by Daniel G. Baker, Barry A. McKibben, Evan Albright, Michael S. Overton, Gregory L. Hoffman and Daniel H. Wolayer, which was filed Aug. 29, 2005 having application No. 60/712,303, which is hereby incorporated herein by reference.

### BRIEF DESCRIPTION OF DRAWINGS

FIG. 1 is block diagram of a system for performing the present method.

FIG. 2 is a block diagram showing additional system detail.

FIG. 3 is a block diagram showing a jitter histogram circuit based on a recovered clock.

FIG. 4 is a flowchart describing the operation of the hardware controller and the jitter analyzer in communication.

FIG. 5 is a display including bathtub curve and an eye diagram with a dynamic jitter indicator based upon a probability value.

### DETAILED DESCRIPTION

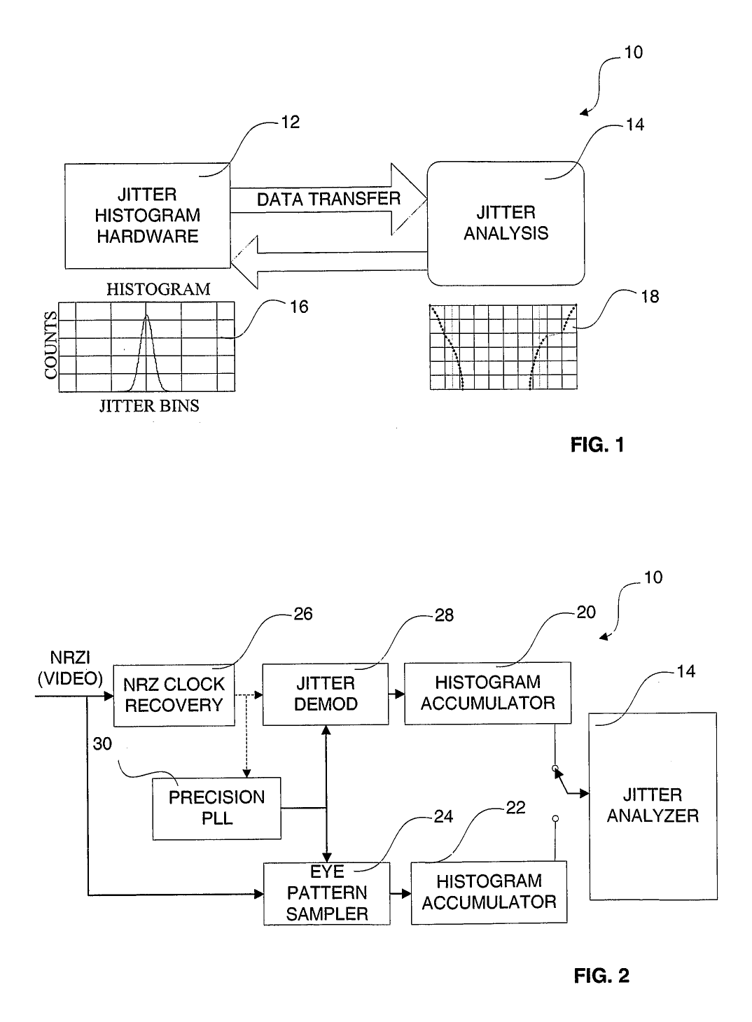

The jitter measurement system 10, shown in FIG. 1, comprises jitter histogram hardware 12 in data communication with a jitter analyzer 14. The jitter histogram hardware 12 is able to build a histogram 16 in memory. The jitter bins correspond to jitter values (time-interval-errors) measured, while the counts correspond to the number of jitter values corresponding to a jitter bin that have been detected. The jitter analyzer 14 can produce jitter measurement values, or a jitter value display 18, based upon associated probability. In an embodiment of the present system and method, the jitter histogram hardware 12 runs continuously on the selected input signal to build the histogram in real-time. The histogram may be produced by detecting time-interval-errors from a recovered clock, or and eye-sampler of the serial signal or some other means of determining the time-interval-error of the serial digital signal transitions. In another embodiment, the histogram hardware 12 automatically rescales as necessary. For example, if the histogram has 32 bits of depth, as a bin reaches, or approaches the 32 bit limit, the entire histogram may be divided by two to rescale it allowing additional jitter values to be counted. The jitter analyzer 14 reads the histogram data from the jitter histogram hardware 12 periodically as needed to update jitter display values, or graphical displays of the jitter, such as a bathtub curve.

As shown in FIG. 2, NRZI coded serial digital video is being measured. The embodiment of the jitter measurement system 10 shown, produces a first histogram 20 of the jitter contained in a recovered clock, and a second histogram 22 taken from an eye pattern sample 24. To produce the first histogram 20 based upon the recovered clock, a clock recovery circuit 26 recovers the clock and jitter demodulator 28 provides the jitter data based upon the recovered clock to the first histogram 20. A precision (low jitter) phase-locked loop (PLL) 30 is shown connected to both the jitter demodulator 28 and the eye pattern sampler 24. The precision PLL 30 tracks the low frequency jitter to a preselected and standardized bandwidth so as to remove those low-frequency components of the jitter as required by the measurement standard. The jitter analyzer 14 can select either histogram to provide corresponding jitter measurement results. Accordingly, the jitter analyzer would be able to provide jitter analysis based upon either the first histogram 20, which is based on the recovered clock, or the second histogram 22, which is derived from the eye pattern sampler. In some embodiments, the jitter analyzer may provide results for each histogram as selected by a user.

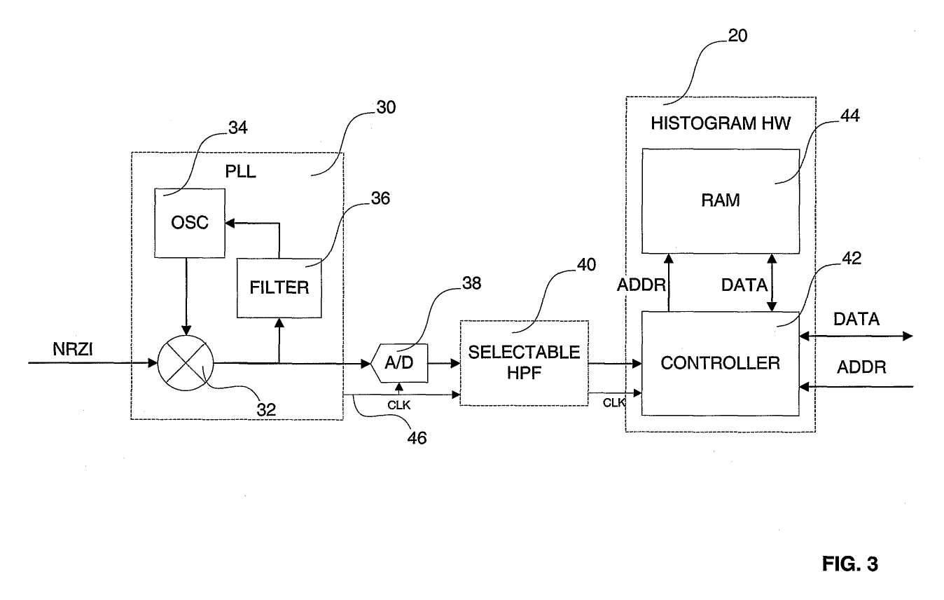

FIG. 3 illustrates an alternative implementation of a jitter histogram hardware 12 based upon a recovered clock. The NRZI serial data is input to a PLL 30 having a phase detector 32 and an oscillator 34 that acts as a jitter demodulator. An error-amp filter is also provided in the feedback path between the phase detector 32 and the oscillator 34. In this example, the NRZI serial data edges are demodulated into an analog jitter signal by the PLL 30, which effectively removes the jitter spectral components below the PLL bandwidth, such that the PLL 30 also provides some high-pass filtering. An analog to digital (A/D) converter 38 then produces discrete jitter data samples from the jitter signal. Some jitter measurement standards, such as IEEE Std 1521-2003, require a 3^{rd} order high-pass filter (HPF) to remove the low-frequency or wander component of the jitter. To comply with these standards, an additional analog HPF or digital HPF filter may be required. An optional HPF 40 is shown in FIG. 3. In some embodiments, the NRZI serial data is equalized to compensate for frequency dependent loss, for example loss due to transmission using coaxial cable. The jitter data samples are input to a controller 42 and written into a RAM 44, which stores the histogram data. The jitter analyzer 14, which is not shown in FIG. 3, is able to access the histogram data. A clock signal (CLK) 46 is shown. The clock signal produces one clock per jitter sample. The clock signal may be generated from the oscillator 34 (although internal connections are not shown) but gated so as to allow the A/D to sample the jitter demodulator output only when a NRZI input transition has occurred. The sample intervals need not be constant. In an alternative embodiment, the clock signal is produced from the NRZI signal using another clock recovery circuit, for example.

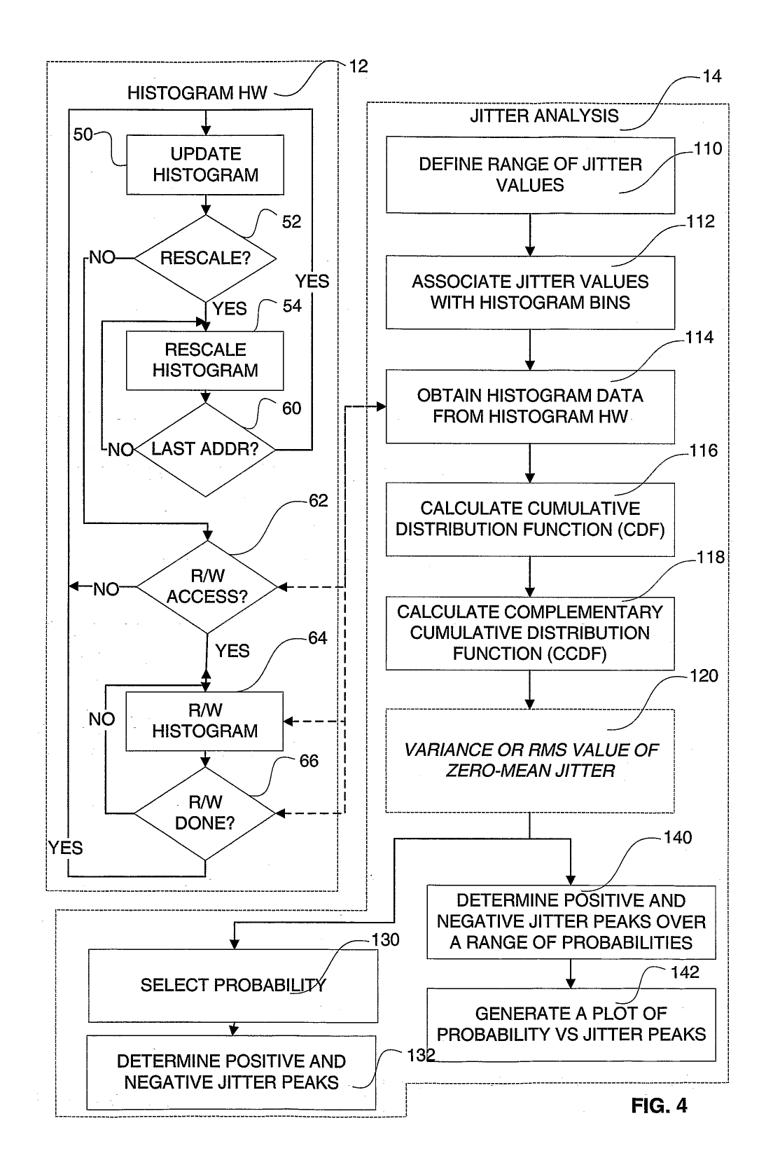

FIG. 4 provides a flowchart illustrating the process flow of an embodiment of the controller 42, along with a flowchart illustrating the process flow of an embodiment of the jitter analyzer 14. The controller 42 updates the histogram in the RAM when a jitter data sample is received as provided at step 50. Each RAM address corresponds to a bin of the histogram. The number of bins should accommodate the range and resolution of jitter data values desired. For example, a 1024×32 bit histogram may be selected. In this case, the jitter data provided should have a comparable range of available time values preferably spanning at least one clock interval of the data. For example, if the histogram has 1024 bins (from 0 to 1023), the A/D converter 38 might provide jitter data having a value between −512 and 511 corresponding to one full clock interval with a resolution of 1/1024 unit of the clock interval. The RAM address would then be equal to the jitter data value plus 512, so that a jitter data value of −512 would cause a count to be written into bin 0, and jitter data value of 511 would cause a count to be written into bin 1023. Each time a jitter data sample is received corresponding to a RAM address, the value stored in at that address would be incremented by one. In alternative embodiments, where additional RAM is used to provide more bins, the jitter data values would be scaled accordingly.

At step 52, the controller determines if it is necessary to rescale the histogram. The histogram may need to be rescaled for example if a specific bin value stored in the RAM reaches, or approaches within a predetermined tolerance, of the maximum allowed value, In our current example, a resealing operation would be indicated if any RAM address had a value equal to the maximum value storable as 32-bit binary value. If a rescale is not necessary, the process continues. If a rescale is indicated, step 54 steps through each RAM address and divides the value by 2, which can be implemented a simple binary shift. This process repeats until the last address has been reached as indicated at step 60. Once the last address has been rescaled, updating the histogram continues at step 50. In an alternative embodiment, the resealing operation could be controlled by the jitter analyzer 14 by reading the histogram data, and normalizing or dividing the data by a desired amount and then writing it back to the RAM. In another embodiment, a reset may also be provided, either using the jitter analyzer to reset the bin values through a R/W operation, or by having a reset operation within the controller 42.

At step 62, the controller 42 determines whether a read/write (R/W) request has been received from the jitter analyzer 14. If not, it continues to update the histogram by returning to step 50. If the jitter analyzer 14 is polling the histogram, for example, the controller 42 would provide the value associated with a histogram bin as data based upon the RAM address corresponding to the address requested by the jitter analyzer 14 as provided at step 64. At step 66, the controller determines if the R/W operation is has been completed. If not, it returns to step 64, otherwise it returns to step 50 to continue updating the histogram. During the short time that the jitter analyzer is reading the RAM or the RAM is being resealed no jitter data would be added to the histogram, however, this represents a negligible data loss.

The histogram hardware 12 is able to independently build the jitter histogram without input from the jitter analyzer 14. The jitter analyzer 14 only needs to poll the histogram data periodically in order to generate a measurement output. Typically, the jitter analyzer 14 would update the display of the results approximately once a second, although it could update more or less frequently as desired. The histogram hardware would be able to receive a significant number of jitter data samples and build, or update, the histogram during that time. In some embodiments, the RAM 44 may be implemented as a dual ported RAM to allow the jitter analyzer to obtain the histogram data without interfering with the histogram update process.

The basic process flow of an embodiment of the jitter analyzer 14 provides for defining a range of jitter values at step 110. In one embodiment, the range of jitter values correspond to the histogram hardware array range expressed in Unit Intervals (UI) of the clock. The range of jitter values could be provided as a fixed value within a test instrument. Alternatively, the range of jitter values could be selected by a user input, provided that the histogram hardware 12 could adjust the jitter data values accordingly to fit in the available number of histogram bins.

The range of jitter values are then associated with the histogram bins of the histogram hardware as provided at step 120. In some embodiments, this would correspond to associating the memory addresses of the histogram bins with a jitter value in UI. Again, this association could be provided as a fixed parameter within the test instrument. Alternatively, an association table could be implement within software. For purposes of illustration, aspects of an implementation of the jitter analyzer designed to be implemented as software on an integer microprocessor will be described.

For example, if the range of jitter values, Jmax to Jmin are defined to be from Jmin=−1.0 UI and Jmax=+1.0 UI for a range of 2 UI around zero, which could be expressed in milliUI as −1000 mUI to +1000 mUI, the association between jitter values and the bin locations within the hardware histogram could be provided using a look-up table. In the case of an integer processor implementation, the following code creates 1024 mUI values to allow the mUI values to be associated with 1024 bins:

Private Sub CreateUILUT( )
′Span from −999 mUI to +1000 mUI, where mUI is milliUI
For i = 1 To 1024

UILUT(i − 1) = Int(2000 * i / 1024) − 1000

Next i
End Sub

Note that this example actually provides a range of jitter values from −999 mUI to +1000 mUI, which is a suitable approximation of the desired −1000 mUI to +1000 mUI.

In step 114, the jitter analyzer 14 obtains histogram data from the histogram hardware. In one embodiment, the entire histogram data is transferred from the histogram hardware when polled by the jitter analyzer 14. In another embodiment, individual histogram values are requested from the histogram hardware as needed to perform calculations.

At step 116, the jitter analyzer calculates the cumulative distribution function (CDF). The CDF is typically determined from the probability density function (PDF), which would correspond to a normalize version of the histogram data. As used herein, the term cumulative distribution function (CDF) will refer to both a normalized CDF based upon a PDF, or to an unnormalized version based upon the unnormalized histogram data. If an unnormalized CDF is being used, it may be necessary to normalize the result during subsequent calculations. In an embodiment of the jitter analyzer, an unnormalized CDF is generated as an array based upon the histogram data.

Similarly, at step 118, the jitter analyzer calculates the complementary cumulative distribution function (CCDF). Again, the CCDF is typically determined from the probability density function (PDF), which would correspond to a normalize version of the histogram data. As the CCDF is related to the CDF, it could be calculated from the CDF calculated in step 116. As used herein, the term complementary cumulative distribution function (CCDF) will refer to both a normalized CCDF, or to an unnormalized version based upon the unnormalized histogram data, or the unnormalized CDF provided by step 116. If an unnormalized CCDF is being used, it may be necessary to normalize the result during subsequent calculations. In an embodiment of the jitter analyzer, an unnormalized CCDF is generated as an array based upon the histogram data.

In an embodiment of the jitter analyzer that computes unnormalized CDF and CCDF arrays, a normalizing scalar value is also computed. The normalizing scalar value corresponds to the last value of the CDF. In another embodiment, a variance (JitVar) or an RMS value of the zero-mean jitter may also be computed, where the RMS value equals the square root of the variance (RMS=√JitVar), as shown in optional step 120. The following code provides unnormalized CDF, and CCDF, as well as a SUMPDF value used for normalizing and the optional variance value (JitVar), which may be used to calculate the RMS.

Private Sub HistoProc( )
Dim Sum(1023) As Double
CDF(0) = Histogram(0)
Sum(0) = (Abs(UILUT(0)) \hat{ } 2) * Histogram(0)
For n = 1 To 1023

CDF(n) = CDF(n − 1) + Histogram(n)
Sum(n) = Sum(n − 1) + (Abs(UILUT(n)) \hat{ } 2) * Histogram(n)

Next n
SumPDF = CDF(1023)
For n = 1 To 1024

CCDF(n − 1) = SumPDF − CDF(n − 1)

Next n
JitVar = Int(Sum(1023) / SumPDF)
End Sub

Once the arrays of unnormalized CDF and CCDF values have been calculated, along with the normalizing value (SUMPDF in this example). The jitter value for the positive jitter (Jpos) and negative jitter (Jneg) peaks can be determined in relation to a probability exponent.

At step 130, a probability is selected. In an embodiment of the jitter analyzer, the probability is selected by a user for example using a data entry region on a user interface to select a probability exponent. Alternatively, the probability exponent is selected automatically by the system, for example to ensure compliance with a test standard. In another embodiment, the probability value is selected as a value rather than specifying just the probability exponent.

At step 132, the positive jitter peak (Jpos or JitPos) and the negative jitter peak (Jneg or JitNeg) are determined based upon the probability value. In an embodiment of the jitter analyzer, the probability based upon the selected probability exponent (Prob) is scaled to match the scale of the unnormalized CDF and CCDF arrays. In an alternative embodiment, the CDF and CCDF arrays could be normalized such that the scaling factor, or normalizing factor, would no longer be needed for subsequent operations. In one embodiment, the positive jitter peak is determined to the be UI value at which the CCDF value is just less than the probability value. For example, to determine the positive jitter peak using the CCDF array described above, the CCDF array is scanned to determine an index at which the CCDF value is less than the corresponding probability value (Po). The jitter peak is the UI value that corresponds to the index. Similarly, the negative jitter peak is determined to be the UI value at which the CDF value is just less than the probability value. So the negative jitter peak would be determined by scanning the CDF array to determine the index at which the CDF value is just below the probability value Po. The following example provides a method for scanning the CCDF and CDF to determine positive jitter peak and the negative jitter peak respectively. The CCDF array is scanned from 0 to the end of the index range (1023) until a value below the probability value (Po) is reached. Then, the resulting index (n) is used to provide the corresponding UI value, which is accomplished using a look-up table in this implementation. In alternative implementations, it would be possible to calculate the UI directly, based upon the index value. In still further embodiments, it would be possible to calculate the UI value directly, without using an index. Similarly, in this example, the CDF array is scanned from the end of the array (1023) towards zero until the CDF value is just less than the probability value. Again, the negative jitter peak is determined by taking the UI value corresponding the to index value (n).

Private Sub JitterPeakVals(Prob)
Dim n As Integer
Po = SumPDF*10\hat{ }(Prob) ‘scaled probability value
n = 0
Do Until (CCDF(n) < Po) Or (n > 1022)

n = n + 1

Loop

JitPos = UILUT(n)
n = 1023
Do Until (CDF(n) < Po) Or (n < 1 )

n = n − 1

Loop
JitNeg = UILUT(n)

End Sub

The peak-to-peak jitter can be readily determined by taking the difference between the positive jitter peak and the negative jitter peak. The preceding example is designed to run on an integer processor, where the index value (n) provides a common index that is generally consistent among the histrogram, provided by the hardware histogram, the UI values provided in the UI look-up table, and the arrays calculated based upon the histogram, CDF and CCDF. As illustrated here, the entire ranges of the CDF and the CCDF arrays are scanned. In alternative embodiments, it is possible to achieve the same, or similar, result by scanning only a portion of the array, for example starting at the middle (jitter values at zero time interval error) and scanning in the appropriate direction. This may speed processing, and prevents getting negative values for JitPos and positive values for JitNeg for selected probability exponents (Prob) between 0 and −1. This may happen when the jitter histogram is skewed such that the mean (typically zero due to high pass filtering described earlier) differs from the median. The median jitter value corresponds to the point where the CDF=0.5.

Once step 132 is finished, the process can return to step 114, which obtains new histogram data. Alternatively, the process could return to step 110 and the range of jitter values could be re-defined to start the entire process over.

In addition to, or in some instances instead of, determining jitter peaks for a single probability value, jitter peaks can be determined over a range of probability values as provided at step 140. Instead of individual values for the positive jitter peak and the negative jitter peak, arrays of positive jitter peaks and negative jitter peaks, respectively, are computed over a range of predetermined probability values. In an embodiment of the jitter analyzer, for each probability value selected within the range of probability values, the CCDF and the CDF are scanned to determine the positive and negative jitter peaks respectively and arrays of jitter peaks over a range of probabilities is produced. The actual scanning process may be performed for each probability value in a manner similar to that described above. The following example code produces arrays of positive jitter peaks (JitPosPeak) and negative jitter peaks (JitNegPeak) values.

Private Sub JitterPeakVals( )

Dim CDFo(24) As Double, Temp As Double
Dim n As Integer
For k = 1 To 25 ‘provides for 24 probability values

Temp = ProbLUT(k − 1) / (10 \hat{ } 12) ‘ use LUT to obtain probability
CDFo(k − 1) = Temp * SumPDF ‘ provided scaled probability value

Next k
For k = 1 To 25

```
  n = 0
  Do Until (CCDF(n) < CDFo(k − 1 )) Or (n > 1022)
```

n = n + 1

```
  Loop
  JitPosPeak(k − 1) = UILUT(n)
```

n = 1023

Do Until (CDF(n) < CDFo(k − 1)) Or (n < 1)

n = n − 1

```
  Loop
  JitNegPeak(k − 1) = UILUT(n)
```

Next k
End Sub

The example code creates an array of positive jitter peaks and negative jitter peaks corresponding to 24 probability exponents. A probability look-up table (ProbLUT) is used to obtain the probability values. For example, for probability exponents from approximately 0 to −12 in half increments could be provided using the following look-up table.

Private Sub CreateProbLUT( ) Equation: ProbLUT(n) = 10\hat{ }(
ProbExp(n) + 12 )
′assign the 64-bit fixed, pre-computed probabilities to the array
ProbLUT(0) = 500034534877# ′Prob exponent = −.301 rather than 0
ProbLUT(1) = 316227766017# ′Prob exponent = −.5,
ProbLUT(2) = 100000000000# ′Prob exponent = −1,
ProbLUT(3) = 31622776602# ′Prob exponent − −1.5,
ProbLUT(4) = 10000000000# ‘and so on...
ProbLUT(5) = 3162277660#
ProbLUT(6) = 1000000000#
ProbLUT(7) = 316227766#
ProbLUT(8) = 100000000#
ProbLUT(9) = 31622777#
ProbLUT(10) = 10000000#
ProbLUT(11) = 3162278#
ProbLUT(12) = 1000000#
ProbLUT(13) = 316228#
ProbLUT(14) = 100000#
ProbLUT(15) = 31623#
ProbLUT(16) = 10000#
ProbLUT(17) = 3162#
ProbLUT(18) = 1000#
ProbLUT(19) = 316#
ProbLUT(20) = 100#
ProbLUT(21) = 32#
ProbLUT(22) = 10#
ProbLUT(23) = 3#
ProbLUT(24) = 1#
End Sub

Values in the example probability look-up table are entered in integer form, rather than real or floating point form, since this example is intended to be implemented using only integer processing. Note that instead of using a probability exponent of zero a value close to zero (0.5=10̂−0.301) was used instead. This is to avoid problems that might be associated with using zero, and to improve the overall appearance of a display of probability vs jitter.

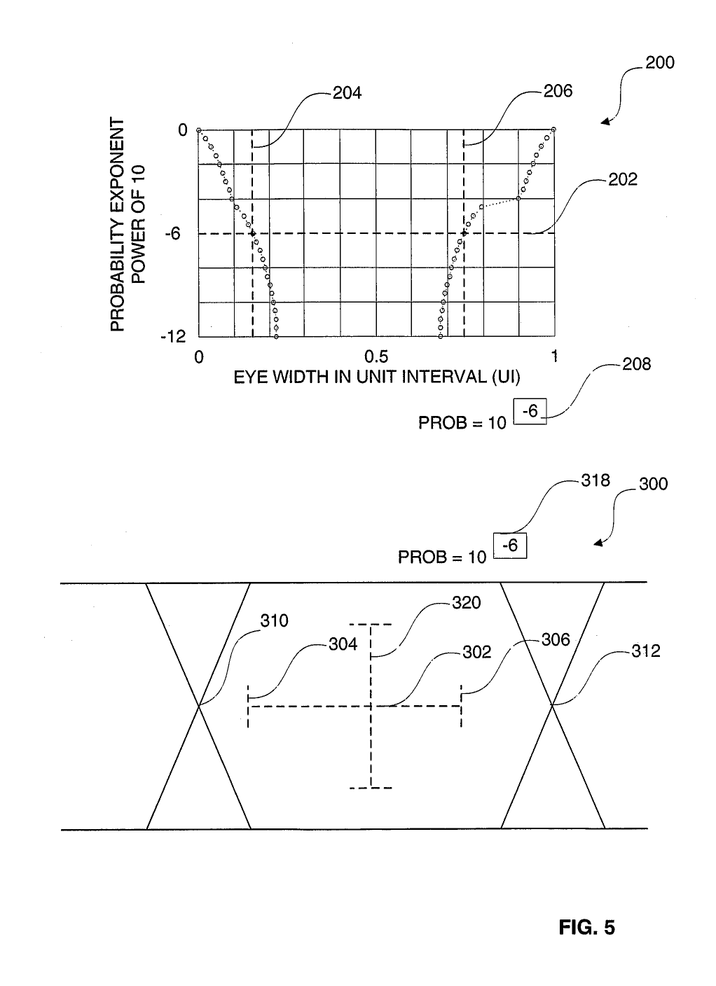

At step 142, the arrays of jitter peak values over a range of probabilities are used to provide a plot, or a display of probability vs jitter peaks. The resulting plot, or display, may be presented for example as a bathtub curve plot, showing probability as a function of jitter in UI, as shown at item 200 in FIG. 5. Bathtub curves are often labeled as bit-error-ratio (BER) vs jitter in UI. The horizontal axis (x-axis) may be expressed in units of time instead by multiplying the UI value by the clock period. Using BER is based on the assumption that a bit error would occur in the receiver if the jitter in the sample of the signal exceeds a particular value on the x-axis (time-axis) of the graph. The probability of that happening is the average BER (ratio of erred bits to non-erred bits).

Once the positive and negative jitter peak arrays have been calculated for a range of probabilities based upon the measured signal histogram, bathtub curve display 200 can be produced, as shown in FIG. 5. In an embodiment of this display, cursors indicating the computed jitter peak threasholds, or receiver accomodation, for a selected BER, or probability, are overlayed on the display. As shown in this example, a line 202 indicating the selected probability is displayed, along with the corresponding negative jitter peak location indicators 204 and the positive jitter peak location indicators 206. In the example of the display 200 shown, a user input box 208 is provided to allow selection of the probability exponent.

FIG. 5 also includes a eye diagram display 300 that incorporates a dynamic jitter limit marker 302. The ends 304 and 306 of the marker 302 correspond to the location of the negative jitter peak and the positive jitter peak respectively. The length of the marker 302 will change as the jitter peak values change based upon the changing histogram provided by the histogram hardware. As shown in FIG. 5 the jitter diagram display 300 and the bathtub curve display 200 are shown together as a combined display with the jitter diagram display positioned below the bathtub curve display and scaled so that the relationship between the two displays is readily discernable. The eye interval in the eye diagram display 300 from 310 to 312 has been scaled to correspond to the dimension from 0 to 1 UI shown in the bathtub curve display 200. Accordingly, the negative jitter peak marker 304 and the positive jitter peak marker 306 are on the same scale as the corresponding location indicators 204 and 206 from display 200. In an alternative embodiment the eye diagram display 300 is positioned above the display 200. Although the two displays are shown together in FIG. 5, in other embodiments either of the displays 200 and 300 may be displayed alone. The eye diagram display 300 also shows an amplitude limit 320 for a selected probability. The amplitude limit would similarly be produced from a hardware histogram of the signal levels in the middle of the eye interval. A second user input box 318 is also shown. In one embodiment, the two boxes would be linked to contain the same probability exponent value and the redunancy would be for user convenience. Alternatively, only a single user input box would be provided. In addition, or instead, a user entry field may be provided outside the display area shown in FIG. 5.

Systems and methods for determining the jitter peak values as a function of probability based upon a hardware histogram have been described above. In some applications where the specified jitter peak values are established, such as by a standard, it would be useful to determine from the histogram what the probability value, or probability exponent, is for selected jitter peak values, or a peak-to-peak value. By using the CDF and CCDF arrays, a selected positive jitter peak threshold and a selected negative peak jitter threshold in UI, the probability, or probability exponents, at which each threshold would be exceeded can be computed. As a first approximation, the positive and negative jitter thresholds can be set to be equal, but opposite. However, in general, equal positive and negative peaks do not occur with the same probability. Accordingly, in some embodiments the process could be run iteratively until appropriate probability values are found for positive and negative jitter values corresponding to a desired peak-to-peak jitter threshold.

The system and method described above uses a hardware system to build a histogram faster than would be possible using a software based histogram system. This data rate enables the present system to build a histogram in a timely fashion. The jitter analyzer system described above could be implemented using software, such as the software described for use with an integer processor. Since the user display only needs to be updated on the order of once a second, modern processors running software are sufficient. In an alternative embodiment, the jitter analyzer, or portions of the jitter analyzer, are implemented using hardware. The hardware could be a dedicated circuit, or a field programmable gate array (FPGA) processor core coded to run the method described. Although the example above was designed to run on an integer processor, a floating point processor could also be used, with the software modified to take advantage of additional processing capability. For example, a floating point processor may reduce the need, or desirability, of using look-up tables to implement aspect of the method.

It will be obvious to those having skill in the art that many changes may be made to the details of the above-described embodiments of this invention without departing from the underlying principles thereof. The scope of the present invention should, therefore, be determined by the following claims.

What is claimed is:

1. A jitter measurement system comprising:
histogram hardware to store jitter data as a histogram; and
a jitter analyzer connected to the histogram hardware to obtain the histogram of jitter data, calculate the CDF and CCDF based upon the histogram, and determine a jitter value based upon a probability value.

2. The jitter measurement system of claim 1, wherein the histogram hardware further comprises a clock recovery circuit to provide the jitter data based upon a clock recovered from a serial video signal.

3. The jitter measurement system of claim 2, wherein the serial video signal is an NRZI signal.

4. The jitter measurement system of claim 1, wherein the histogram hardware further comprises an eye pattern sample to provide the jitter data based upon a serial video signal.

5. The jitter measurement system of claim 1, wherein the jitter analyzer comprises software running on an integer processor.

6. The jitter measurement system of claim 1, wherein the jitter analyzer is implemented using an FPGA.

7. The jitter measurement system of claim 1, wherein the jitter analyzer comprises a floating point processor running software.

8. The jitter measurement system of claim 1, further comprising a display having a dynamic jitter limit marker overlayed on an eye diagram, wherein the dynamic jitter limit marker has a first end corresponding to a positive jitter value obtained based on the probability value and a second end corresponding to a negative jitter value based upon the probability value.

9. The jitter measurement system of claim 1, wherein the jitter analyzer provides an array of jitter value based upon a range of probabilities, and the jitter measurement system further comprises a display of probability values as a function of jitter values.

10. The jitter measurement system of claim 1, wherein the jitter analyzer provides an array of jitter value based upon a range of probabilities, and the jitter measurement system further comprises a display of BER values as a function of jitter values.

11. A method of measuring jitter comprising:
creating a histogram of jitter values within histogram hardware;
transferring the histogram from the histogram hardware to a jitter analyzer;
calculating a cumulative distribution function (CDF);
calculating a complementary cumulative distribution function (CCDF); and
determining a jitter peak based upon a selected probability value and the cumulative distribution function or the complementary distribution function.

12. The method of claim 11, wherein determining a jitter peak comprises determining a positive jitter peak by identifying a CCDF value less than or equal to a probability value based upon the selected probability is reached, and returning the corresponding jitter value.

13. The method of claim 12, wherein identifying the CCDF value is achieved by scanning an array of CCDF values until a CCDF value less than the probability value is found.

14. The method of claim 11, wherein determining a jitter peak comprises determining a negative jitter peak by scanning the CDF until a CDF value below a probability value based upon the selected probability is reached, and returning the corresponding jitter value.

15. The method of claim 14, wherein identifying the CDF value is achieved by scanning an array of CDF values until a CDF value less than the probability value is found.

16. The method of claim 11, further comprising determining postive jitter values and negative jitter values over a range of probabilities, and generating a plot of probability versus jitter values.

17. The method of claim 11, further comprising determining a positive jitter value and a negative jitter value based on the selected probability, and generating a eye diagram with a dynamic jitter limit marker with one end corresponding to the positive jitter value and another end corresponding to the negative jitter value.

18. A jitter measurement system comprising;
a hardware histogram to store jitter data;
a means for transferring the hardware histogram to jitter analyzer;
a means for calculating a cumulative distribution function array within the jitter analyzer based upon the hardware histogram;
a means for calculating a complementary cumulative distribution function array within the jitter analyzer based upon the hardware histogram;
means for determining a positive jitter peak within the jitter analyzer based upon a probability value and the complementary cumulative distribution function array;
means for determining a negative jitter peak within the jitter analyzer based upon the probability value and the cumulative distribution function array; and
means for displaying the positive jitter peak and the negative jitter peak.
